(19) United States
(12) Patent Application Publication
(10) Pub. No.: US 2024/0402510 A1
(43) Pub. Date: Dec. 5, 2024

(54) OPTICAL SYSTEM, ITS MANUFACTURING METHOD, AND IMAGE PICKUP APPARATUS

(71) Applicant: CANON KABUSHIKI KAISHA, Tokyo (JP)

(72) Inventor: Kentaro MORI, Tochigi (JP)

(21) Appl. No.: 18/676,566

(22) Filed: May 29, 2024

(30) Foreign Application Priority Data
May 30, 2023 (JP) 2023-089275
Apr. 10, 2024 (JP) 2024-063175

(51) Int. Cl. G02B 27/42; G02B 27/00; H04N 23/55

(52) U.S. Cl. CPC G02B 27/4266; G02B 27/0012; H04N 23/55

(57) ABSTRACT

An optical system includes a diffractive surface, and one or more non-planar refractive surfaces. The diffractive surface satisfies predetermined equations.

### BACKGROUND

### Technical Field

One of the aspects of the embodiments relates to an optical system having a diffractive surface.

### Description of Related Art

A method of expressing a diffractive surface in a geometric optics manner using an optical path difference function is disclosed in Hiroshi Miyamae, “Geometrical Optical Treatment of Diffractive Lens System,” Optics, Vol. 27, No. 9, pp. 513-519 (1998) and Japanese Patent No. 7086709. Various optical systems including a diffractive surface that has been designed using this method are also known.

Each of U.S. Patent Applications Publication Nos. 2022/0082794 and 2022/0206186, and U.S. Pat. No. 10,670,782 discloses a meta-surface lens including a nanostructure having a geometry of a subwavelength of incident light. The light deflecting action of the meta-surface lens can be handled by the generalized Snell's law similarly to that of the diffractive surface, but unlike the conventional diffractive surfaces, it is known that the meta-surface lens can control its dispersion.

The optical system having a diffractive surface using an optical path difference function as disclosed in Hiroshi Miyamae, “Geometrical Optical Treatment of Diffractive Lens System,” Optics, Vol. 27, No. 9, pp. 513-519 (1998) and Japanese Patent No. 7086709 has a problem in uncontrollability of the dispersion of the diffractive surface because the dispersion of the diffractive surface is determined only by the wavelength. U.S. Patent Applications Publication Nos. 2022/0082794 and 2022/0206186 disclose dispersion control examples using the meta-surface, but their descriptions are too qualitative to provide geometric optics design because they do not disclose any specific practical numerical values.

U.S. Pat. No. 10,670,782 discloses a design and manufacturing method of a dispersion-controlled meta-surface element in which a phase retardation amount of metaatoms is calculated for each wavelength and metaatoms are arranged so as to control the dispersion of the meta-surface element. However, it is not efficient to use an element design method based on the electromagnetic field analysis for designing an optical system including a refractive surface and the like. Similarly to the optical design using the conventional diffractive surface, an optical design using geometric optics is demanded.

### SUMMARY

An optical system according to one aspect of the disclosure includes a diffractive surface, and one or more non-planar refractive surfaces. ψ is an optical path difference function of the diffractive surface, m is a diffraction order, λ₀ is a designed wavelength of the diffractive surface, λ is an incident wavelength, P*(λ) is optical path difference dispersion of a surface, ψ₀ is an optical path difference function of a surface at the designed wavelength, and the optical path difference function ψ of the optical path difference function ψ₀*(λ) of the surface, and the optical path difference function ψ₀*(λ) of the surface and the optical path difference function ψ of the diffractive surface are defined as follows:

$${ψ}_{0}^{★} ( λ ) ≡ {P}^{★} ( λ ) {ψ}_{0}$$

$$ψ ≡ m \frac{λ}{{λ}_{0}} {ψ}_{0}^{★} ( λ ) .$$

Then, the diffractive surface satisfies the following equations:

$$\{ \begin{matrix}{P}^{★} ( λ ) \neq 1.0 \\ {P}^{★} ( {λ}_{0} ) = 1.0\end{matrix}$$

An image pickup apparatus having the above optical system and a manufacturing method of the above optical system also constitute another aspect of the disclosure. A method using the above equations for causing a computer to output or calculate the optical path difference function ψ of a diffractive surface, and a storage medium storing a program that causes a computer to execute this method also constitute another aspect of the disclosure. A designing method for designing an optical system including a diffractive surface using the above equations also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 illustrates a slope of an optical path difference function of a surface at a designed wavelength.

FIG. 2 illustrates the slope of the optical path difference function of the surface.

FIG. 3 is a sectional view of an optical system according to Example 1.

FIG. 4 is an aberration diagram of the optical system according to Example 1.

FIG. 5 is a sectional view of an optical system according to Example 2.

FIG. 6 is an aberration diagram of the optical system according to Example 2.

FIG. 7 is a sectional view of an optical system according to Example 3.

FIG. 8 is an aberration diagram of the optical system according to Example 3.

FIG. 9 illustrates an image pickup apparatus using the optical system according to any one of Examples 1 to 3.

### DESCRIPTION OF THE EMBODIMENTS

Examples of the present disclosure will be described below with reference to the accompanying drawings. Prior to a specific description of Examples 1 to 3, a description will now be given of matters common to each example.

In order to clarify a difference between an optical design using a dispersion-controlled diffractive surface according to each example and an optical design using the conventional diffractive surface, a description will now be given of the optical design using the optical path difference function of the conventional diffractive surface. It is known that light deflection by a diffractive surface follows the following equation for a diffraction grating:

$${N}^{′} sin {θ}^{′} = N sin θ + m \frac{λ}{{P}_{0}} \qquad ( 1 )$$

where N is a refractive index of an incident medium, θ is an incident angle, N′ is a refractive index of an exit medium, θ′ is an exit angle, m is a diffraction order, λ is an incident wavelength, and P₀ is a grating pitch.

Equation (1) is expressed using an optical path difference function ψ₀ of the surface at a designed wavelength. FIG. 1 illustrates a relationship between a slope |∇ψ₀| of an optical path difference function. From FIG. 1, the slope |∇ψ₀| of this optical path difference function can be expressed as follows using the grating pitch P₀ and the designed wavelength λ0 of the diffraction grating.

$$\vert ∇ {ψ}_{0} \vert = \frac{{λ}_{0}}{{P}_{0}} \qquad ( 2 )$$

Using equation (2), equation (1) can be expressed as follows.

$${N}^{′} sin {θ}^{′} = N sin θ + m \frac{λ}{{λ}_{0}} \vert ∇ {ψ}_{0} \vert \qquad ( 3 )$$

Equation (3) is the diffractive surface expression of the conventional generalized Snell's law. In a case where the generalized Snell's law of equation (3) is expressed as a vector using a ray direction unit vector, it can be expressed as follows:

$${N}^{′} \vec{{s}^{′}} \times \vec{n} = N \vec{s} \times \vec{n} + m \frac{λ}{{λ}_{0}} ∇ {ψ}_{0} \times \vec{n} \qquad ( 4 )$$

where \vec{S} is an incident ray direction unit vector, \vec{n} is a surface normal unit vector at a ray passing point on an optical surface, and \vec{s′} is an exit ray direction unit vector. Conventionally, ray tracing of an optical system including a diffractive surface has been usually calculated using equation (4). The optical path difference function ψ₀ of the surface at the designed wavelength is usually expressed by the following polynomial in a case where the surface is a rotationally symmetric surface that is frequently used.

$${ψ}_{0} = {U}_{2} {h}^{2} + {U}_{4} {h}^{4} + {U}_{6} {h}^{6} + … \qquad ( 5 )$$

where h is a distance from the optical axis.

One characteristic of the conventional diffractive surface is that dispersion is determined only by wavelength. For this description, the Abbe number ψ₀ of the conventional diffractive surface is calculated. Thereby, a conceptual difference between the conventional diffractive surface and the dispersion-controlled diffractive surface according to each example can be found.

From the above description, the optical path difference function ψ of the diffractive surface can be expressed as follows using the optical path difference function ψ₀ of the surface at the designed wavelength.

$$ψ = m \frac{λ}{{λ}_{0}} {ψ}_{0} \qquad ( 6 )$$

In order to derive the Abbe number of the conventional diffractive surface, differentiating equation (6) with respect to the wavelength λ can provide the following equation:

$$d ψ = m \frac{d λ}{{λ}_{0}} {ψ}_{0} \qquad ( 7 )$$

The Abbe number ν₀ can be defined as a relative change in the optical path difference function ψ when the wavelength changes. Therefore, dividing both sides of equation (7) by the optical path difference function ψ and rearranging it using equation (6), the Abbe number ψ₀ of the conventional diffractive surface can be derived as follows:

$$\frac{1}{{v}_{0}} = \frac{d ψ}{ψ} = \frac{d λ}{λ} \qquad ( 8 )$$

A reciprocal of the Abbe number is called a dispersion rate.

From the right side of equation (8), the dispersion of the conventional diffractive surface is determined only by the wavelength. More specifically, when the reference wavelength is a wavelength of the d-line (0.58756 μm) and the primary dispersion uses the F-line (0.48613 μm) and the C-line (0.65627 μm), the Abbe number ν_{0,d} of the conventional diffractive surface has the following value:

$$\begin{matrix}\frac{1}{{v}_{0 , d}} = \frac{{λ}_{F} - {λ}_{C}}{{λ}_{d}} = \frac{0.48613 - 0.65627}{0.58756} = - 0.28957 \\ {v}_{0 , d} = - 3.4 \; 53\end{matrix} \qquad ( 9 )$$

A description will now be given of the optical design of the dispersion-controlled diffractive surface according to each example. Due to the recent development of the microfabrication technology, dispersion-controlled meta-surface lenses have appeared. The simplest meta-surface lens, which is made of cylindrical pillars made of a single material, lacks the degree of freedom in chromatic phase dispersion, so it basically has approximately the same dispersion characteristic as that of the conventional diffractive lens. However, even if a phase delay amount at the reference wavelength is the same, methods such as preparing metaatoms with various structures can make different phase delay amounts at other wavelengths for each metaatom structure. Dispersion-controlled meta-surface lenses achieve dispersion control of the diffractive surface using such metaatoms.

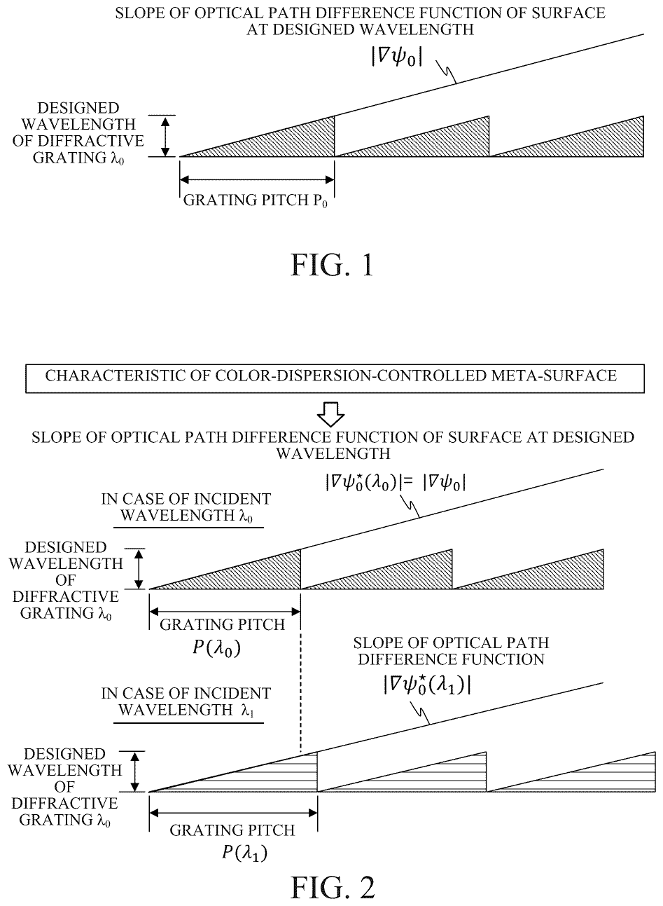

For the optical design using a dispersion-controlled diffractive surface, this effect is expressed in the geometric optics manner. The dispersion control of the diffractive surface using the meta-surface described above can be considered to realize a refractive index distribution type diffraction grating having a different grating pitch for each wavelength by disposing various metaatoms with different characteristics. FIG. 2 illustrates a relationship of a slope |∇ψ₀*(λ)| of an optical path difference function of a surface in this case. From FIG. 2, the slope |∇ψ₀*(λ)| of the optical path difference function of the surface can be expressed as follows using the grating pitch P(λ) and the designed wavelength λ₀ of the diffraction grating:

$$\vert ∇ {ψ}_{0}^{⋆} ( λ ) \vert ≡ \frac{{λ}_{0}}{P ( λ )} = \frac{{P}_{0}}{P ( λ )} \vert ∇ {ψ}_{0} \vert = P * ( λ ) \vert ∇ {ψ}_{0} \vert \qquad ( 10 )$$

where P*(λ) is optical path difference dispersion of the surface. (λ) is added to explicitly indicate that the grating pitch and the slope of the optical path difference function of the surface is a function of wavelength.

Based on this concept, equation (1) of the diffraction grating can be rewritten as follows:

$${N}^{′} sin {θ}^{′} = N sin θ + m \frac{λ}{P ( λ )} \qquad ( 11 )$$

Equation (11) using equation (10) can be expressed as the generalized Snell's law corresponding to a dispersion-controlled diffractive surface as follows.

$${N}^{′} sin {θ}^{′} = N sin θ + m \frac{λ}{{λ}_{0}} \vert ∇ {ψ}_{0}^{⋆} ( λ ) \vert \qquad ( 12 )$$

Equation (12) can be expressed as a vector using a ray direction unit vector as follows:

$${N}^{′} \vec{{s}^{′}} \times \vec{n} = N \vec{s} \times \vec{n} + m \frac{λ}{{λ}_{0}} ∇ {ψ}_{0}^{⋆} ( λ ) \times \vec{n} \qquad ( 13 )$$

Use of equation (13) enables ray tracing and the optical design of an optical system using a dispersion-controlled diffractive surface. In a case where the optical path difference dispersion of the surface is set to P*(λ)=1, it corresponds to equation (4) that deals with the conventional diffractive surface.

The Abbe number ν₀* of the dispersion-controlled diffractive surface will be derived, and the difference from the Abbe number ν0 of the conventional diffractive surface will be explained. From the above explanation, the optical path difference function ψ can be expressed as follows using the surface optical path difference function ψ₀*(λ):

$$ψ = m \frac{λ}{{λ}_{0}} {ψ}_{0}^{⋆} ( λ ) \qquad ( 14 )$$

In order to derive the Abbe number of the dispersion-controlled diffractive surface, differentiating equation (14) with respect to the wavelength λ can provide the following equation:

$$d ψ = m \frac{d λ}{{λ}_{0}} {ψ}_{0}^{⋆} ( λ ) + m \frac{λ}{{λ}_{0}} d {ψ}_{0}^{⋆} ( λ ) \qquad ( 15 )$$

The Abbe number ν₀* can be defined as a relative change in the optical path difference function ψ when the wavelength changes. Therefore, by dividing both sides of equation (15) by the optical path difference function d and rearranging it using equation (14), the Abbe number ν₀* of the dispersion-controlled diffractive surface can be derived as follows:

$$\frac{1}{{v}_{0}^{⋆}} = \frac{d ψ}{ψ} = \frac{d λ}{λ} + \frac{d {ψ}_{0}^{⋆} ( λ )}{{ψ}_{0}^{⋆} ( λ )} \qquad ( 16 )$$

The difference from the Abbe number of the conventional diffractive surface is that the second term on the right side of equation (16) contains the wavelength dispersion term of the optical path difference function of the surface. The existence of this term is the characteristic of the dispersion-controlled diffractive surface. In other words, the Abbe number ν₀* of a dispersion-controlled diffractive surface has not only the wavelength term but also the optical path difference function term of the surface that depends on the wavelength, and thereby the value of the Abbe number ν₀* can be controlled utilizing the degree of freedom of the optical path difference function. Thereby, chromatic aberration can be further corrected in comparison with the conventional diffractive surface.

From the above, it is understood that the dispersion of the diffractive surface can be controlled by controlling the wavelength dispersion of the optical path difference function of the surface.

The above is the concept for designing an optical system using the dispersion-controlled diffractive surface according to each example. Therefore, the optical system according to each example including a diffractive surface and one or more non-planar refractive surfaces has the following characteristic: The diffractive surface satisfies the following equations:

$$\{ \begin{matrix}{P}^{*} ( λ ) \neq 1. \\ {P}^{*} ( {λ}_{0} ) = 1.0\end{matrix} \qquad ( C1 )$$

where ψ is an optical path difference function of the diffractive surface, m is a diffraction order, λ₀ is a designed wavelength of the diffractive surface, λ is an incident wavelength, P*(λ) is optical path difference dispersion of a surface, ψ₀ is an optical path difference function of the surface at the designed wavelength, and the optical path difference function ψ of the optical path difference function ψ₀*(λ) of the surface and the diffractive surface is defined as follows:

$${ψ}_{0}^{⋆} ( λ ) ≡ {P}^{*} ( λ ) {ψ}_{0}$$

$$ψ ≡ m \frac{λ}{{λ}_{0}} {ψ}_{0}^{⋆} ( λ )$$

Equations (C1) define a condition that enables an optical design using a dispersion-controlled diffractive surface and obtains a reduced size and high optical performance. Setting a diffractive surface that satisfies equations (C1) enables the optical design using a dispersion-controlled diffractive surface. The conventional diffractive surface has chromatic dispersion larger than that of glass, and the entire optical system needs a large number of refractive lenses are required to correct chromatic aberration. Using a dispersion-controlled diffractive surface can achieve the dispersion suitable for correcting chromatic aberration, and provide an optical system that has a reduced size and high optical performance.

The optical systems according to Examples 1 to 3 (corresponding numerical examples 1 to 3) satisfy equations (C1), so they enable the optical design using the dispersion-controlled diffractive surface, and have a reduced size and high optical performance.

In each example, at least one of the following inequalities may be satisfied.

In a case where the reference wavelength is the wavelength of the d-line and the primary dispersion uses the F-line and the C-line, the dispersion rate dψ0_{id}* of the optical path difference function of the surface may be set so as to satisfy the following inequality:

$$0.0 < d {ψ}_{0 , d}^{⋆} < 0.4 \qquad ( C2 )$$

Inequality (C2) defines a condition for easily obtaining an optical system that has a reduced size and high optical performance using a dispersion-controlled diffractive surface. In a case where the dispersion rate dψ_{0,d}* of the optical path difference function of the surface is lower than the lower limit of inequality (C2), the negative dispersion generated on the diffractive surface becomes too large, it becomes thus difficult to perform chromatic correction for the entire optical system, and it becomes difficult to obtain high optical performance. In a case where the dispersion rate dψ_{0,d}* of the optical path difference function of the surface becomes higher than the upper limit of inequality (C2), the dispersion generated on the dispersion-controlled diffractive surface becomes positive dispersion similarly to that of ordinary glass, and it becomes difficult to reduce the size of the optical system.

Inequality (C2) may be replaced with the following inequality (C2a):

$$0.05 < d {ψ}_{0 , d}^{⋆} < 0 \text{.35} \qquad ( C2a )$$

Inequality (C2) may be replaced with the following inequality (C2b):

$$0.1 < d {ψ}_{0 , d}^{⋆} < 0.3 \qquad ( C2b )$$

In a case where the reference wavelength is the wavelength of the d-line, the primary dispersion uses the g-line and the F-line, and the dispersion rate dψ_{g,f} of the optical path difference function of the diffractive surface may be set so as to satisfy the following inequality:

$$- 0.080 < d {ψ}_{g , F} \leq 0.0 \; 01 \qquad ( C3 )$$

Inequality (C3) defines a condition for easily obtaining an optical system that has a reduced size and high optical performance using a dispersion-controlled diffractive surface. In a case where the dispersion rate ddψ_{g,F} of the optical path difference function becomes lower than the lower limit of inequality (C3), the slopes of the g-line and the F-line become close to those of a normal diffractive surface. As a result, it becomes difficult to correct the secondary spectrum, especially in combination with a refractive surface and thus to obtain high optical performance. In a case where the dispersion rate dψg,F of the optical path difference function becomes higher than the upper limit of inequality (C3), the dispersion generated on the dispersion-controlled diffractive surface becomes positive dispersion similarly to that of ordinary glass, and it becomes difficult to reduce the size of the optical system.

Inequality (C3) may be replaced with the following inequality (C3a):

$$- 0.01 < d {ψ}_{g , F} \leq 0 \text{.00} \qquad ( C3a )$$

Inequality (C3) may be replaced with the following inequality (C3b):

$$- 0.008 < d {ψ}_{g , F} \leq 0.0 \; 00 \qquad ( C3b )$$

The following inequality may be satisfied:

$$0 \text{.4} < \vert fmoe \vert / f < 30.0 \qquad ( C4 )$$

where fmoe is a focal length of the diffractive surface of the dispersion control diffractive optical element, and f is a focal length of the entire optical system including the diffractive optical element.

Inequality (C4) defines a condition for easily obtaining an optical system that has a reduced size and high optical performance using a dispersion-controlled diffractive surface. In a case where the focal length fmoe on the diffractive surface is lower than the lower limit of inequality (C4), various aberrations such as spherical aberration and coma occur, and it becomes difficult to obtain high optical performance. In a case where the focal length fmoe on the diffractive surface becomes higher than the upper limit of inequality (C4), it becomes difficult to reduce the size of the optical system.

Inequality (C4) may be replaced with the following inequality (C4a):

$$0 \text{.6} < \vert fmoe \vert / f < 2 0. \qquad ( C4a )$$

Inequality (C4) may be replaced with the following inequality (C4b):

$$0 \text{.8} < \vert fmoe \vert / f < 15. \qquad ( C4b )$$

The following inequality may be satisfied:

$$0.04 < skd / TL < 0.30 \qquad ( C5 )$$

where skd is a back focus from a lens surface closest to the image plane of the optical system to the image plane, and TL is an overall optical length (overall lens length) from a lens surface closest to the object to the image surface.

In a case where a glass block is placed between the optical system and the image plane, which has refractive power of substantially 0 for on-axis and off-axis rays, the back focus has an air conversion value except for the glass block.

Inequality (C5) defines a condition for easily obtaining an optical system having a reduced size. In a case where the back focus is short so that skd/TL is lower than the lower limit of inequality (C5), the distance between the optical system and the image plane becomes too short, and it becomes difficult to place the cover glass or thermal changes in the optical system due to heat from the image sensor disposed on the image plane are not negligible. In a case where the back focus is so long that skd/TL becomes higher than the upper limit of inequality (C5), it becomes difficult to reduce the size of the optical system.

Inequality (C5) may be replaced with the following inequality (C5a):

$$0.06 < skd / TL < 0.25 \qquad ( C5a )$$

Inequality (C5) may be replaced with the following inequality (C5b):

$$0.08 < skd / TL < 0.2 \qquad ( C5b )$$

Designing (manufacturing) the optical system according to each example using the optical path difference dispersion P*(λ) of the surface as an optimization variable can easily set the dispersion characteristic of the diffractive surface suitable to correct the chromatic aberration in the optical system.

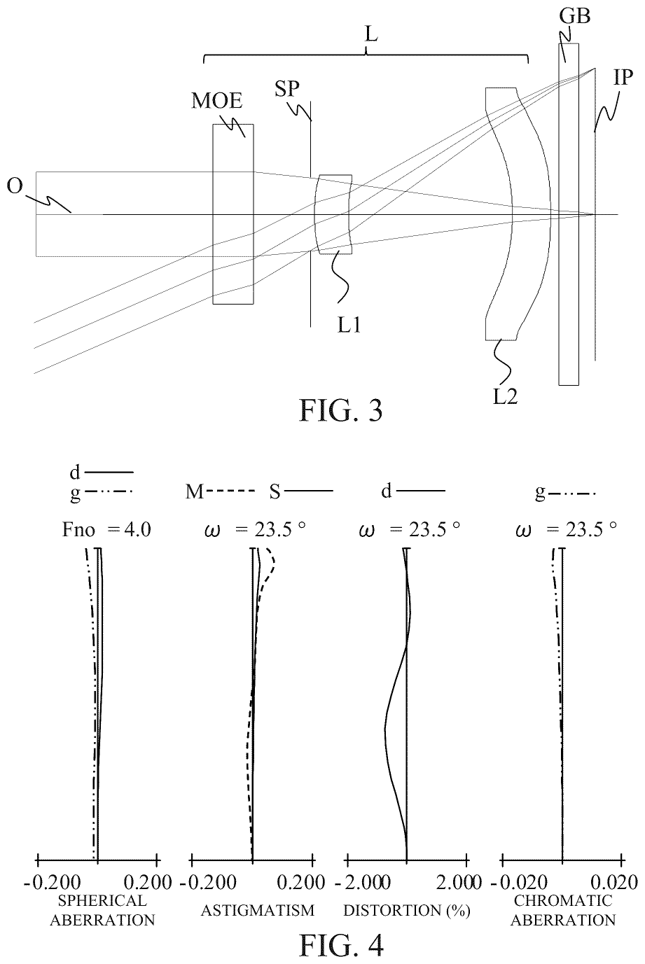

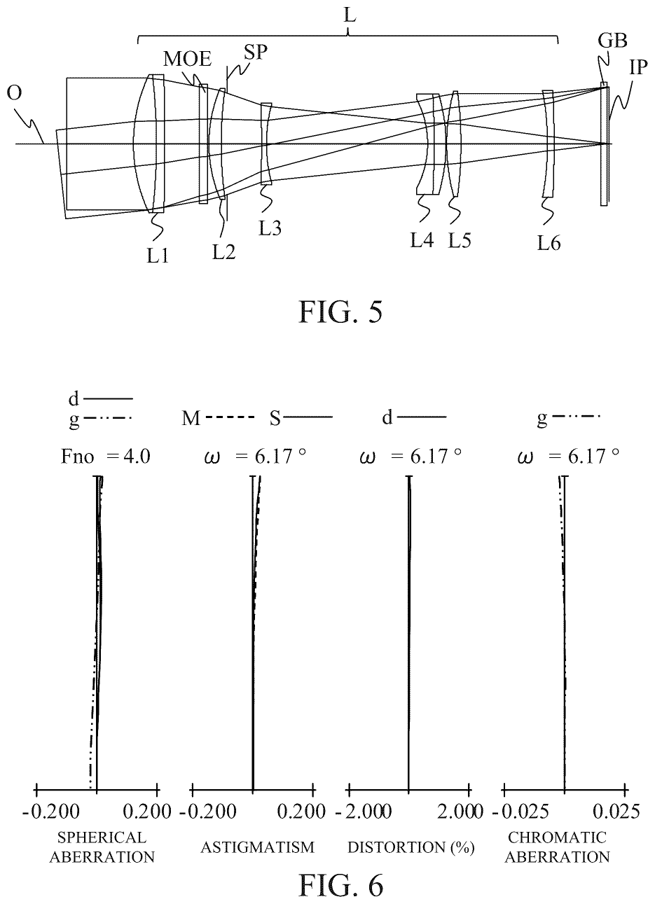

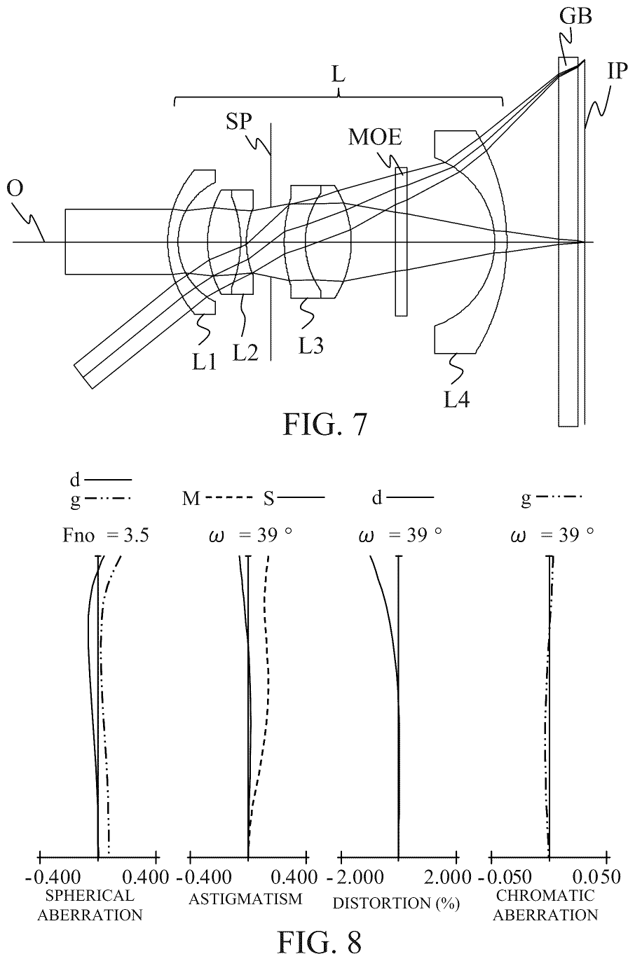

Examples 1 to 3 will now be described. After Example 3, numerical examples 1 to 3 corresponding to Examples 1 to 3 will be illustrated. FIGS. 3, 5, and 7 illustrate the optical systems L according to Examples 1, 2 and 3, respectively. O represents an optical axis of the optical system L. MOE represents a diffractive optical element optically designed using an optical path difference function, SP represents an aperture stop, GB represents a glass block, and IP represents an image plane. Disposed on the image plane IP is an imaging surface (light receiving surface) of an image sensor such as a CCD sensor or a CMOS sensor, or a film surface (photosensitive surface) of a film-based camera.

### Example 1

The optical system according to Example 1 (numerical example 1) is an optical system with a focal length of 8.30 mm, an F-number of 4.0, and a half angle of view of 23.5 degrees. The optical system L includes, in order from the object side to the image side, a dispersion-controlled diffractive optical element MOE, an aperture stop SP, an aspherical lens L1 having positive refractive power, and an aspherical lens L2 having negative refractive power.

The diffractive optical element MOE has positive refractive power, and its optical path difference function has optical path difference dispersion of a surface defined so as to prevent chromatic aberration. This configuration can converge a light beam without generating chromatic aberration, and achieve an optical system having a reduced size and high image quality.

The aperture stop SP serves to determine the F-number of the optical system. Disposed on the image side of the aperture stop SP are a positive meniscus aspherical lens L1 that is convex on the object side and a negative meniscus aspherical lens L2 that is convex on the image side. Although chromatic aberration does not occur in the diffractive optical element MOE, monochromatic aberrations such as coma and curvature of field cannot be corrected with a single diffractive surface. Therefore, various aberrations such as coma and curvature of field are effectively corrected by these two aspherical lenses L1 and L2.

The aspheric lens L2 closest to the image plane is disposed at a position close to the image plane IP, and effectively corrects various aberrations such as curvature of field and distortion.

Numerical example 1 satisfies all inequalities (C1) to (C5). Thereby, the optical system L according to numerical example 1 has a reduced size and high optical performance. Strictly speaking, the optical path difference dispersion of the surface in numerical example 1 does not become 0 in the decimal places that are much smaller than 1.0, but it can be substantially regarded as 1. This also applies to other numerical examples described below.

FIG. 4 illustrates longitudinal aberrations (spherical aberration, astigmatism, distortion, and chromatic aberration) of the optical system L according to numerical example 1. In the spherical aberration diagram, Fno represents an F-number. A solid line indicates a spherical aberration amount for the d-line (wavelength 587.6 nm), and an alternate long and two short dashes line indicates a spherical aberration amount for the g-line (wavelength 435.8 nm). In the astigmatism diagram, a solid line S indicates an astigmatism amount on the sagittal image plane, and a broken line M indicates an astigmatism amount on the meridional image plane. The distortion diagram illustrates a distortion amount for the d-line. The chromatic aberration diagram illustrates a lateral chromatic aberration amount for the g-line. ω is a half angle of view (°).

### Example 2

The optical system L according to Example 2 is an optical system with a focal length of 200 mm, an F-number of 4.0, and a half angle of view of 6.17 degrees, and includes a dispersion-controlled diffractive optical element MOE.

The optical system L includes, in order from the object side to the image side, a cemented lens L1 as a biconvex positive lens and a negative meniscus lens that is convex on the image side, a diffractive optical element MOE having positive refractive power in which optical path difference dispersion of a surface is defined so as to provide negative dispersion weaker than dispersion of a normal diffractive surface, a positive meniscus lens L2 that is convex on the object side, an aperture stop SP, a biconcave negative lens L3, a cemented lens L4 of a negative meniscus lens that is convex on the image side and a positive meniscus lens that is convex on the image side, a positive biconvex lens L5, and a negative meniscus lens L6 that is convex on the image side.

The configuration using the diffractive optical element MOE effectively converges an on-axis light beam while correcting chromatic aberration, achieving a reduced size and high performance of the optical system L. The negative meniscus lens L6 closest to the image plane is disposed at a position where the back focus becomes short. This configuration can effectively correct various aberrations such as curvature of field and distortion.

Numerical example 2 satisfies all inequalities (C1) to (C5). Thereby, the optical system L according to numerical example 2 has a reduced size and high optical performance. FIG. 6 illustrates a longitudinal aberration of the optical system L according to numerical example 2.

### Example 3

The optical system L according to Example 3 is an optical system with a focal length of 27 mm, an F-number of 3.5, and a half angle of view of 38.71 degrees, and includes a dispersion-controlled diffractive optical element MOE.

The optical system L includes, in order from the object side to the image side, a negative meniscus lens L1 that is convex on the object side, a cemented lens L2 of a biconvex positive lens and a biconcave negative lens, an aperture stop SP, a cemented lens L3 of a biconvex positive lens and a negative meniscus lens that is convex on the object side, a diffractive optical element MOE having positive refractive power in which optical path difference dispersion of a surface is defined so as to provide negative dispersion weaker than the dispersion of a normal diffractive surface, and a negative meniscus lens L4 that is convex on the image side. The configuration using the diffractive optical element MOE can effectively correct chromatic aberration and achieves a reduced size and high performance of the optical system L. The negative meniscus lens L4 closest to the image plane is disposed at a position where the back focus becomes short. This configuration can effectively correct various aberrations such as curvature of field and distortion.

Numerical example 3 satisfies all inequalities (C1) to (C5). Thereby, the optical system L according to numerical example 3 has a reduced size and high optical performance. FIG. 8 illustrates a longitudinal aberration of the optical system L according to numerical example 3.

Each example may correct aberrations by image processing. The configuration that realizes the optical path difference function of the diffractive optical element may be a so-called single-layer type meta-surface consisting of a single layer, or a so-called lamination type meta-surface consisting of a plurality of layers. The glass block GB may be a low-pass filter, an IR cut filter, or the like.

Numerical examples 1 to 3 will be illustrated below. In each numerical example, i represents an order of the surfaces counted from the object side, r represents a radius of curvature (mm) of an i-th optical surface (i-th surface), and d is an on-axis distance (mm) along the optical axis between i-th and (i+1)-th optical surfaces. nd and vd are the refractive index for the d-line of the material of the i-th optical member and the Abbe number based on the d-line, respectively.

The Abbe number of a certain material is represented as follows:

$$vd = ( Nd - 1 ) / ( NF - NC )$$

where Nd, NF, and NC are refractive indexes of the d-line (587.6 nm), F-line (486.1 nm), and C-line (656.3 nm) in the Fraunhofer line. An effective diameter indicates a radius (mm) of an area on the i-th surface through which rays contributing to imaging pass.

BF represents back focus (mm) and corresponds to skd in inequality (C5). The back focus is a distance on the optical axis from the final surface (the surface closest to the image plane) of the optical system to the paraxial image surface expressed in terms of air equivalent length. The “overall lens length” is a length of the optical system from the frontmost surface (the surface closest to the object) to the final surface on the optical axis plus the back focus, and corresponds to the overall optical length TL in inequality (C5).

An asterisk “*” attached to the right side of a surface number means that the optical surface is aspheric. The aspherical shape is expressed as follows:

$$x = ( {h}^{2} / R ) / [ 1 + {\{ 1 - ( 1 + k ) {( h / R )}^{2} \}}^{1 / 2} ] + A 4 \times {h}^{4} + A 6 \times {h}^{6} + A 8 \times {h}^{8} + A 10 \times {h}^{10}$$

where x is a displacement amount from the surface vertex in the optical axis direction, h is a height from the optical axis in the direction perpendicular to the optical axis, R is a paraxial radius of curvature, k is a conical constant, and A4, A6, A8, and A10 are aspherical coefficients of each order. “e±XX” in each aspherical coefficient means “×10^{±XX}.”

The optical path difference function of the surface at the designed wavelength is expressed by the following equation:

$$ψ0 = U 2 \cdot {h}^{2} + U 4 \cdot {h}^{4} + U 6 \cdot {h}^{6} + U 8 \cdot {h}^{8} + U 10 \cdot {h}^{10}$$

where U2 to U10 are coefficients of the optical path difference function of the surface.

(Diffraction) appended to a surface number means that the surface has been optically designed using the optical path difference function of the surface.

Table 1 summarizes values of inequalities (C2) to (C5) in numerical examples 1 to 3.

### Numerical Example 1

UNIT: mm
SURFACE DATA

| Surface No. | | r | d | nd | vd | Effective Diameter |
|---|---|---|---|---|---|---|
| | 1 | ∞ | 1.00 | 1.45867 | 67.9 | 4.02 |
| | 2 (diffraction) | ∞ | 1.40 | 3.45 | | |
| | 3 (SP) | ∞ | 0.10 | 1.80 | | |
| | 4* | 5.249 | 0.84 | 1.53504 | 55.7 | 1.76 |
| | 5* | 5.830 | 4.03 | 1.49 | | |
| | 6* | −5.666 | 0.94 | 1.53504 | 55.7 | 4.85 |
| | 7* | −13.238 | 0.20 | 5.61 | | |
| | 8 | ∞ | 0.50 | 1.51633 | 64.1 | 7.50 |
| | 9 | ∞ | 0.40 | 7.50 | | |
| | Image Plane | ∞ | | | | |

ASPHERIC DATA
2nd Surface (diffractive surface)
Designed Wavelength 0.58756 [μm]
U 2 = −5.74195e−02 U 4= 4.82532e−03 U 6 = −1.48309e−04 U 8= 7.34398e−06
Optical Path Difference Dispersion of Surface

${P}^{⋆} ( λ ) = \frac{0.58756}{λ}$
4th Surface
K = −2.03720e+00 A 4 = 4.95415e−02 A 6 = −4.78711e−03
A 8 = 7.21202e−03 A10 = −2.39213e−03
5th Surface
K = −9.00000e+01 A 4 = 1.08601e−01 A 6 = −6.76262e−02
A 8 = 7.61853e−02 A10 = −3.32147e−02
6th Surface
K = 5.77917e−01 A 4 = −1.12096e−02 A 6 = 2.16691e−03
A 8 = −1.71105e−04 A10 = 1.38988e−05
7th Surface
K = 8.52623e+00 A 4 = −2.28992e−02 A 6 = 4.42728e−03
A 8 = −4.87943e−04 A10 = −2.36572e−05

VARIOUS DATA

| | |
|---|---|
| Focal Length | 8.30 |
| Fno | 4.00 |
| Half Angle of View [°] | 23.45 |
| Image Height | 3.60 |
| Overall Lens Length | 9.23 |
| BF | 0.93 |
| Incident Pupil Position | 2.35 |
| Exit Pupil Position | −5.07 |
| Front Principal-Point Position | −1.94 |
| Rear Principal-Point Position | −7.90 |

| Lens | Starting Surface | Focal Length |
|---|---|---|
| 1 | 1 | 8.71 |
| 2 | 4 | 65.51 |
| 3 | 6 | −19.35 |

### Numerical Example 2

UNIT: mm
SURFACE DATA

| | | | | | Effective |
|---|---|---|---|---|---|
| Surface No. | r | d | nd | vd | Diameter |
| 1 | 61.911 | 8.68 | 1.48749 | 70.2 | 50.00 |
| 2 | −222.009 | 3.00 | 1.71700 | 47.9 | 49.42 |
| 3 | −2123.992 | 13.31 | 48.52 | | |
| 4 (diffraction) | ∞ | 3.00 | 1.51633 | 64.1 | 43.29 |
| 5 | ∞ | 0.50 | 42.41 | | |
| 6 | 54.277 | 4.80 | 1.43875 | 94.9 | 40.42 |
| 7 | 184.876 | 2.05 | 39.35 | | |
| 8 (SP) | 00 | 13.00 | 38.63 | | |
| 9 | −573.923 | 2.00 | 1.88300 | 40.8 | 29.45 |
| 10 | 60.092 | 60.85 | 28.14 | | |
| 11 | −36.149 | 2.50 | 1.43875 | 94.9 | 32.19 |
| 12 | −474.734 | 4.44 | 1.59270 | 35.3 | 34.98 |
| 13 | −72.341 | 0.50 | 36.04 | | |
| 14 | 84.046 | 5.40 | 1.50137 | 56.4 | 37.91 |
| 15 | −150.289 | 32.69 | 38.09 | | |
| 16 | −114.359 | 2.50 | 1.80810 | 22.8 | 38.22 |
| 17 | −550.552 | 17.68 | 38.79 | | |
| 18 | ∞ | 2.30 | 1.51633 | 64.1 | 45.00 |
| 19 | ∞ | 0.80 | 45.00 | | |
| Image Plane | ∞ | | | | |

ASPHERIC DATA
4th Surface (diffractive surface)
Designed Wavelength 0.58756 [μm]
U 2 = −7.35292e−04 U 4 = 6.05791e−08
U 6 = −4.57447e−12 U 8 = 3.81537e−15
Optical Path Difference Dispersion Of Surface
P*(λ) = 11.98025λ¹⁰ − 112.89596λ⁹ + 636.82804λ⁸ − 2386.30858λ⁷ +
6238.01513λ⁶ − 11608.79622λ⁵ + 15381.86627λ⁴ −
14223.54349λ³ + 8743.66646λ² − 3216.94218λ + 536.9241
VARIOUS DATA

| Focal Length | 200.00 | |
|---|---|---|
| Fno | 4.00 | |
| Half Angle of | 6.17 | |
| View [°] | | |
| Image Height | 21.64 | |
| Overall Lens | 179.22 | |
| Length | | |
| BF | 20.00 | |
| Incident Pupil | 37.07 | |
| Position | | |
| Exit Pupil Position | −117.74 | |
| Front Principal- | −100.38 | |
| Point Position | | |
| Rear Principal- | −199.20 | |
| Point Position | | |
| | Starting | |
| Lens | Surface | Focal Length |
| 1 | 1 | 100.31 |
| 2 | 2 | −346.00 |
| 3 | 4 | 680.00 |
| 4 | 6 | 173.18 |
| 5 | 9 | −61.51 |
| 6 | 11 | −89.34 |
| 7 | 12 | 143.41 |
| 8 | 14 | 108.34 |
| 9 | 16 | −179.08 |

### Numerical Example 3

UNIT: mm
SURFACE DATA

| | | | | | Effective |
|---|---|---|---|---|---|
| Surface No. | r | d | nd | vd | Diameter |
| 1 | 13.135 | 1.20 | 1.48749 | 70.2 | 16.05 |
| 2 | 7.897 | 3.54 | 13.03 | | |
| 3 | 12.791 | 3.90 | 1.80440 | 39.6 | 11.39 |
| 4 | −14.146 | 0.70 | 1.87400 | 35.3 | 9.51 |
| 5 | 10.511 | 2.93 | 7.38 | | |
| 6 (SP) | 00 | 1.57 | 8.27 | | |
| 7 | 17.749 | 2.50 | 1.83400 | 37.2 | 9.12 |
| 8 | 10.021 | 5.45 | 1.62041 | 60.3 | 10.48 |
| 9 | −12.483 | 5.26 | 12.27 | | |
| 10 (diffraction) | ∞ | 1.40 | 1.45867 | 67.9 | 16.05 |
| 11 | ∞ | 10.41 | 16.55 | | |
| 12 | −10.557 | 1.44 | 1.59270 | 35.3 | 18.92 |
| 13 | −25.297 | 6.18 | 24.72 | | |
| 14 | ∞ | 2.30 | 1.51633 | 64.1 | 39.95 |
| 15 | ∞ | 0.80 | 42.05 | | |
| Image Plane | ∞ | | | | |

ASPHERIC DATA
10th Surface (diffractive surface)
Designed Wavelength 0.58756 [μm]
U 2 = −1.57703e−03 U 4 = 5.74967e−06
U 6 = −6.03016e−08 U 8 = 7.50090e−10
Optical Path Difference Dispersion of Surface
P*(2) = 12.24651λ¹⁰ − 119.47401λ⁹ + 698.93911λ⁸ − 2720.50404λ⁷ +
7400.15723λ⁶ − 14357.24904λ⁵ + 19873.44252λ⁴ −
19240.95159λ³ + 12415.10756λ² − 4807.96577λ +
847.46929
VARIOUS DATA

| Focal Length | 27.00 | |
|---|---|---|
| Fno | 3.50 | |
| Half Angle | 38.71 | |
| of View[°] | | |
| Image Height | 21.64 | |
| Overall Lens | 48.80 | |
| Length | | |
| BF | 8.50 | |
| Incident Pupil | 9.80 | |
| Position | | |
| Exit Pupil Position | −23.50 | |
| Front Principal- | 6.80 | |
| Point Position | | |
| Rear Principal- | −26.20 | |
| Point Position | | |
| | Starting | |
| Lens | Surface | Focal Length |
| 1 | 1 | −43.92 |
| 2 | 3 | 8.93 |
| 3 | 4 | −6.81 |
| 4 | 7 | −32.36 |
| 5 | 8 | 9.87 |
| 6 | 10 | 317.05 |
| 7 | 12 | −31.72 |

TABLE 1

| | Numerical Ex. 1 | Numerical Ex. 2 | Numerical Ex. 3 |
|---|---|---|---|
| Inequality (2) | 0.2896 | 0.2763 | 0.2661 |
| Inequality (3) | 0.000 | −0.00247 | −0.00399 |
| Inequality (4) | 1.05 | 3.40 | 11.77 |
| Inequality (5) | 0.10 | 0.11 | 0.17 |

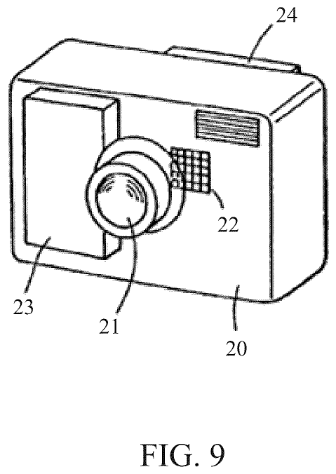

FIG. 9 illustrates a digital still camera as an image pickup apparatus using the optical system according to any one of the above examples as an imaging optical system. Reference numeral 20 denotes a camera body, and reference numeral 21 denotes an imaging optical system that includes the optical system according to any one of Examples 1 to 3. Reference numeral 22 denotes an image sensor such as a CCD sensor or a CMOS sensor, which is built into the camera body 20 and captures an optical image (object image) formed by the imaging optical system 21. Reference numeral 23 denotes a recorder that records image data generated by processing an imaging signal from the image sensor 22, and reference numeral 24 denotes a rear display unit that displays image data.

Using the optical system according to each example can provide a camera having a reduced size and high optical performance. The camera may be a single-lens reflex camera with a quick turn mirror, or a mirrorless camera without a quick turn mirror.

Examples of the disclosure also include a method for causing one or more processors (computer) to output or calculate the optical path difference function of a diffractive surface using the equations explained in each example, and a storage medium storing a program that causes one or more processors (computer) to execute this method. Furthermore, a designing method for designing an optical system including a diffractive surface using the equations explained in each example is also included as examples of the disclosure.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can achieve an optical design using a dispersion-controlled diffractive surface, and can provide an optical system with a reduced size and high optical performance.

This application claims priority to Japanese Patent Applications Nos. 2023-089275, which was filed on May 30, 2023, and 2024-063175, which was filed on Apr. 10, 2024 which are hereby incorporated by reference herein in their entirety.

What is claimed is:

1. An optical system comprising:
a diffractive surface; and
one or more non-planar refractive surfaces,
wherein where ψ is an optical path difference function of the diffractive surface, m is a diffraction order, λ₀ is a designed wavelength of the diffractive surface, λ is an incident wavelength, P*(λ) is optical path difference dispersion of a surface, ψ₀ is an optical path difference function of a surface at the designed wavelength, and the optical path difference function ψ of the optical path difference function ψ₀*(λ) of the surface, and the optical path difference function ψ₀*(λ) of the surface and the optical path difference function ψ of the diffractive surface are defined as follows:
$$\begin{matrix}{ψ}_{0}^{★} ( λ ) ≡ {P}^{★} ( λ ) {ψ}_{0} \\ ψ ≡ m \frac{λ}{{λ}_{0}} {ψ}_{0}^{★} ( λ )\end{matrix}$$
the diffractive surface satisfies the following equations:
$$\{ \begin{matrix}{P}^{★} ( λ ) \neq 1. \\ {P}^{★} ( {λ}_{0} ) = 1.\end{matrix}$$

2. The optical system according to claim 1, wherein the following inequality is satisfied:
$$0. < d {ψ}_{0 , d}^{★} < 0.4$$
where a reference wavelength is a wavelength of d-line, primary dispersion uses F-line and C-line, and dψ_{0,d}* is a dispersion rate of the optical path difference function of the surface.

3. The optical system according to claim 1, wherein the following inequality is satisfied:
$$- 0.08 < d {ψ}_{g , F} \leq 0.001$$
where a reference wavelength is a wavelength of d-line, primary dispersion uses g-line and F-line, and dψ_{g,F} is a dispersion rate of the optical path difference function of the diffractive surface.

4. The optical system according to claim 1, wherein the following inequality is satisfied:
$$0.04 < fmoe / f < 30.$$
where fmoe is a focal length of the diffractive surface provided on a diffractive optical element, and f is a focal length of the optical system including the diffractive optical element.

5. The optical system according to claim 1, wherein the following inequality is satisfied:
$$0.04 < skd / TL < 0.3$$
where skd is a back focus from a lens surface closest to an image plane in the optical system to the image plane, and TL is an overall optical length from a lens surface closest to an object in the optical system to the image plane.

6. The optical system according to claim 1, wherein the optical system is designed by setting the optical path difference dispersion P*(λ) of the surface as an optimization variable.

7. An image pickup apparatus comprising:
an optical system; and
an image sensor configured to capture an object via the optical system,
wherein the optical system includes:
a diffractive surface; and
one or more non-planar refractive surfaces,
wherein where ψ is an optical path difference function of the diffractive surface, m is a diffraction order, λ₀ is a designed wavelength of the diffractive surface, λ is an incident wavelength, P*(λ) is optical path difference dispersion of a surface, ψ₀ is an optical path difference function of a surface at the designed wavelength, and the optical path difference function w of the optical path difference function ψ₀*(λ) of the surface, and the optical path difference function ψ₀*(λ) of the surface and the optical path difference function w of the diffractive surface are defined as follows:
$$\begin{matrix}{ψ}_{0}^{★} ( λ ) ≡ {P}^{★} ( λ ) {ψ}_{0} \\ ψ ≡ m \frac{λ}{{λ}_{0}} {ψ}_{0}^{★} ( λ )\end{matrix}$$
the diffractive surface satisfies the following equations:
$$\{ \begin{matrix}{P}^{★} ( λ ) \neq 1. \\ {P}^{★} ( {λ}_{0} ) = 1.\end{matrix}$$

8. A method for manufacturing an optical system including a diffractive surface and one or more non-planar refractive surfaces, the method comprising the step of designing the optical system by setting optical path difference dispersion of a surface as an optimization variable so that the diffractive surface satisfies the following equations:
$$\{ \begin{matrix}{P}^{★} ( λ ) \neq 1. \\ {P}^{★} ( {λ}_{0} ) = 1.\end{matrix}$$
where ψ is an optical path difference function of the diffractive surface, m is a diffraction order, λ₀ is a designed wavelength of the diffractive surface, λ is an incident wavelength, P*(λ) is the optical path difference dispersion of the surface, ψ₀ is an optical path difference function of a surface at the designed wavelength, and the optical path difference function w of the optical path difference function ψ₀*(λ) of the surface and the diffractive surface is defined as follows:
$$\begin{matrix}{ψ}_{0}^{★} ( λ ) ≡ {P}^{★} ( λ ) {ψ}_{0} \\ ψ ≡ m \frac{λ}{{λ}_{0}} {ψ}_{0}^{★} ( λ )\end{matrix}$$

9. A method to be executed by a computer, where ψ is an optical path difference function of a diffractive surface, m is a diffraction order, λ₀ is a designed wavelength of the diffractive surface, λ is an incident wavelength, P*(λ) is optical path difference dispersion of a surface, ψ₀ is an optical path difference function of a surface at the designed wavelength, and the optical path difference function ψ of the optical path difference function ψ₀*(λ) of the surface, which are defined as follows:
$$\begin{matrix}{ψ}_{0}^{★} ( λ ) ≡ {P}^{★} ( λ ) {ψ}_{0} \\ ψ ≡ m \frac{λ}{{λ}_{0}} {ψ}_{0}^{★} ( λ ) \\ \{ \begin{matrix}{P}^{★} ( λ ) \neq 1. \\ {P}^{★} ( {λ}_{0} ) = 1.\end{matrix}\end{matrix}$$
the method comprising the steps of:
acquiring the diffraction order m, the design wavelength λ₀, and the incident wavelength λ; and
outputting the optical path difference function ψ of the diffractive surface based on the optical path difference dispersion P*(λ), the optical path difference function ψ₀, and the diffraction order m, the design wavelength λ₀, and the incident wavelength λ acquired by the acquiring step.

10. A method to be executed by a computer, where ψ is an optical path difference function of a diffractive surface, m is a diffraction order, λ₀ is a designed wavelength of the diffractive surface, λ is an incident wavelength, P*(λ) is optical path difference dispersion of a surface, ψ₀ is an optical path difference function of a surface at the designed wavelength, and the optical path difference function ψ of the optical path difference function ψ₀*(λ) of the surface, which are defined as follows:
$$\begin{matrix}{ψ}_{0}^{★} ( λ ) ≡ {P}^{★} ( λ ) {ψ}_{0} \\ ψ ≡ m \frac{λ}{{λ}_{0}} {ψ}_{0}^{★} ( λ )\end{matrix}$$
the method comprising the steps of:
acquiring the incident wavelength λ;
inputting the optical path difference dispersion P*(λ) that is different between a case where the incident wavelength λ is the design wavelength λ₀ and a case where when the incident wavelength λ is other than the design wavelength λ₀;
outputting the optical path difference function ψ of the diffractive surface based on the input optical path difference dispersion P*(λ), the diffraction order m, the design wavelength λ₀, the incident wavelength λ, and the optical path difference function ψ₀.

11. A non-transitory computer-readable storage medium storing a program that causes a computer to execute the method according to claim 9.

12. A non-transitory computer-readable storage medium storing a program that causes a computer to execute the method according to claim 10.

13. A designing method for designing an optical system including a diffractive surface, where ψ is an optical path difference function of a diffractive surface, m is a diffraction order, λ₀ is a designed wavelength of the diffractive surface, λ is an incident wavelength, P*(λ) is optical path difference dispersion of a surface, ψ₀ is an optical path difference function of a surface at the designed wavelength, and the optical path difference function ψ of the optical path difference function ψ₀*(λ) of the surface, which are defined as follows:
$$\begin{matrix}{ψ}_{0}^{★} ( λ ) ≡ {P}^{★} ( λ ) {ψ}_{0} \\ ψ ≡ m \frac{λ}{{λ}_{0}} {ψ}_{0}^{★} ( λ ) \\ \{ \begin{matrix}{P}^{★} ( λ ) \neq 1. \\ {P}^{★} ( {λ}_{0} ) = 1.\end{matrix}\end{matrix}$$
the method comprising calculating the optical path difference function ψ of the diffractive surface.
